(19) United States
(12) Patent Application Publication
(10) Pub. No.: US 2017/0370528 A1
(43) Pub. Date: Dec. 28, 2017

(54) Omnidirectional Lighting Device

(71) Applicant: Aleddra Inc., Renton, WA (US)

(72) Inventors: Chia-Yiu Maa, Bellevue, WA (US); Chun-Te Yu, Renton, WA (US)

(21) Appl. No.: 15/700,029

(22) Filed: Sep. 8, 2017

Related U.S. Application Data
(63) Continuation-in-part of application No. 14/995,142, filed on Jan. 13, 2016.

(51) Int. Cl. F21K 9/23; F21K 9/60; F21V 23/00; F21V 23/06; H01J 61/00; F21Y 2115/10; F21Y 2115/15

(52) U.S. Cl. CPC F21K 9/23; F21V 23/003; F21K 9/60; F21V 23/06; F21Y 2115/10; F21Y 2115/15; H01J 61/00

(57) ABSTRACT

An omnidirectional lighting device may include a driver base and a plurality of elongated light sources. The driver base may include a driver configured to convert an external alternating-current (AC) power to a direct-current (DC) power and supply the DC power to the plurality of elongated light sources. Each of the plurality of elongated light sources protrudes independently out of a second side of the driver base, and each source is enclosed with a cylindrical lens. The plurality of the cylindrical lenses are aligned in parallel and of the same length. An aggregate lighting angle of the plurality of elongated light source may be 360 degrees.

### CROSS REFERENCE TO RELATED PATENT APPLICATION(S)

The present disclosure is part of a continuation-in-part (CIP) application of U.S. patent application Ser. No. 14/995,142 filed on 13 Jan. 2016, the content of which is incorporated by reference in its entirety.

### TECHNICAL FIELD

The present disclosure pertains to the field of lighting devices and, more specifically, proposes a multi-source light-emitting diode (LED) lighting device.

### BACKGROUND

Edison-base and PL-base compact fluorescent (CFL) lamps have been widely used for commercial lighting in luminaires such as recessed can fixture, surface-mount ceiling fixture, decorated wall-mount fixture, and even exterior wall pack fixture. For PL-based CFL lamps, they usually take the form of 2-source, 4-source, or even 6-source. While the PL-based CFL lamp saves energy as compared to the incandescent lamp, it has several drawbacks. Firstly, it takes some time to warm up, thus it can't put out 100% light immediately upon turning on. Secondly, its lifetime affects by the on-off cycle. While it could save energy when using the PL-based CFL lamp together with a motion sensor, the frequent on-off cycles due to motion-sensing has negative impact on lamp's life. Thirdly, the lifetime of CFL lamp at 6,000 to 8,000 hours is not long enough, thus its replacement becomes one of the major lighting maintenance tasks for commercial facility management team.

LED technology has been applied to PL-base lamps recently. However, due to the directional lighting nature of the LED light source, the PL-base LED has the limitation of producing one directional lighting, as opposed to the omnidirectional lighting by the CFL lamp. Thus PL-base LED lamp used in a CFL fixture, it can't replicate the same lighting distribution as of the CFL lamp. Moreover, the PL-base socket can be either horizontally or vertically aligned. No one PL-based LED lamp can be used in both scenarios. Two types of PL-based LED lamp, the horizontal-mount type and the vertical-mount type, were devised to meet this mounting need, which resulting additional inventory cost of stock both types of PL-based LED lamp.

The present disclosure presents an omnidirectional lamp that mimics the form factor of the PL-based CFL lamp by using a plurality of elongated light sources where each is enclosed with a cylindrical lens. The aggregate lighting angle of the plurality of the elongated light sources is 360-degree, thus overcoming all drawbacks mentioned above with the CFL lamp and the LED-diode based PL lamp.

### SUMMARY

In one aspect, the lighting device that comprises a driver base and more than one elongated DC-powered light sources. The driver base contains a driver for converting external AC power to DC power and then supplying DC power to power the more than one elongated light sources. The more than one elongated DC-powered light sources protrude independently out of the driver base. Moreover, the aggregate lighting angle of the more than one elongated light sources is 360 degrees. Each of the more than one elongated light sources is enclosed with a cylindrical lens, and these cylindrical lenses are aligned in parallel and of the same length.

Unlike conventional LED CFL replacement lamp that normally comprises of only one LED lighting source, the present disclosure has multiple light sources thus having two advantages over traditional single light source design. Firstly, each light source can be independent oriented, thus widening the overall lighting angle of the lighting device to 360 degrees even though the lighting angle of each individual light source is less than 360 degrees. Secondly, each light source has its own lighting surface, thus increasing the overall lighting surface area, as well as increasing the overall heat dissipation area, with the benefit of better heat management and longer lifetime for the lighting device that uses heat-sensitive light source such as LED.

In some embodiments, the cylindrical lens may be transparent or translucent or partially transparent and partially translucent. When needed, as in some other embodiments, a filtering material may be applied to the cylindrical lens for filtering the light emitted out of the light source.

In some embodiments, the space between the cylindrical lens and the elongated light source may be vacuum or filled with inert gas. This increase the safety of the lighting device.

In some embodiments, the elongated light source may be an LED array, a filament-style LED light source, or an Organic LED (OLED) light sources aligned in an elongated style.

In some embodiments, one side of the driver base is an electric connector that may take the form of any screw-in base (e.g., Edison-based E13/E26/E39, etc.), pin-base (e.g., PL, MR16, GU10, etc.), hole-base socket connector, any standard or non-standard electrical connector, or any combination thereof.

In some embodiments, the more than one elongated DC-powered light sources may form a driver-less sub-assembly, and the driver base itself may form another sub-assembly. The two sub-assemblies may be combined through a locking mechanism without using an external force or an additional part or component. One benefit of having such design is that it easier to detach and replace the driver base when it dies. This is because the driver lifetime is less than that of the LED diodes and sources. With a plug-and-play replaceable driver base, the lifetime of the lighting device can be extended without replacing it completely. Another benefit of such design is that the end user can upgrade the driver base with a new functionality becomes available. For example, the original driver base may not have the dimming capability. The next generation driver base may be dimmable. Or the original driver base may not be controllable via a wireless control, while the new driver base is wireless controllable via a smartphone app, for example. With a plug-and-playable locking mechanism or interface between the multi-source assembly and the driver base assembly, the driver base is upgradeable easily and cost-effectively.

### BRIEF DESCRIPTION OF THE DRAWINGS

The accompanying drawings are included to aid further understanding of the present disclosure, and are incorporated in and constitute a part of the present disclosure. The drawings illustrate a select number of embodiments of the present disclosure and, together with the detailed description below, serve to explain the principles of the present disclosure. It is appreciable that the drawings are not necessarily in scale as some components may be shown to be out of proportion than the size in actual implementation in order to clearly illustrate the concept of the present disclosure.

FIG. 1A schematically depicts a diagram of a 2-pin PL-based lighting device with four elongated light sources each enclosed with a cylindrical lens in accordance with the present disclosure.

FIG. 1B schematically depicts a driver connection diagram of the 4-source LED lighting device in accordance with the present disclosure.

FIG. 2A schematically depicts a diagram of a 2-pin PL-based lighting device with six elongated light sources each enclosed with a cylindrical lens in accordance with the present disclosure.

FIG. 2B schematically depicts a driver connection diagram of the 6-source LED lighting device in accordance with the present disclosure.

FIG. 3A schematically depicts a diagram of a 2-pin PL-based lighting device with eight elongated light sources each enclosed with a cylindrical lens in accordance with the present disclosure.

FIG. 3B schematically depicts a driver connection diagram of the 8-source LED lighting device in accordance with the present disclosure.

FIG. 4 schematically depicts another embodiment of the present disclosure.

### DETAILED DESCRIPTION OF PREFERRED EMBODIMENTS

### Overview

Various implementations of the present disclosure and related inventive concepts are described below. It should be acknowledged, however, that the present disclosure is not limited to any particular manner of implementation, and that the various embodiments discussed explicitly herein are primarily for purposes of illustration. For example, the various concepts discussed herein may be suitably implemented in a variety of lighting devices having different form factors.

The present disclosure discloses a lighting device that comprises a driver base and more than one elongated DC-powered light sources. The driver base contains a driver for converting external AC power to DC power and then supplying DC power to power the more than one elongated light sources. The more than one elongated DC-powered light sources protrude independently out of the driver base. Moreover, the aggregate lighting angle of the more than one elongated DC-powered light sources is 360 degrees. Each of the plurality of elongated light source is enclosed with a cylindrical lens, and these cylindrical lenses are aligned in parallel and of the same length.

### Example Implementations

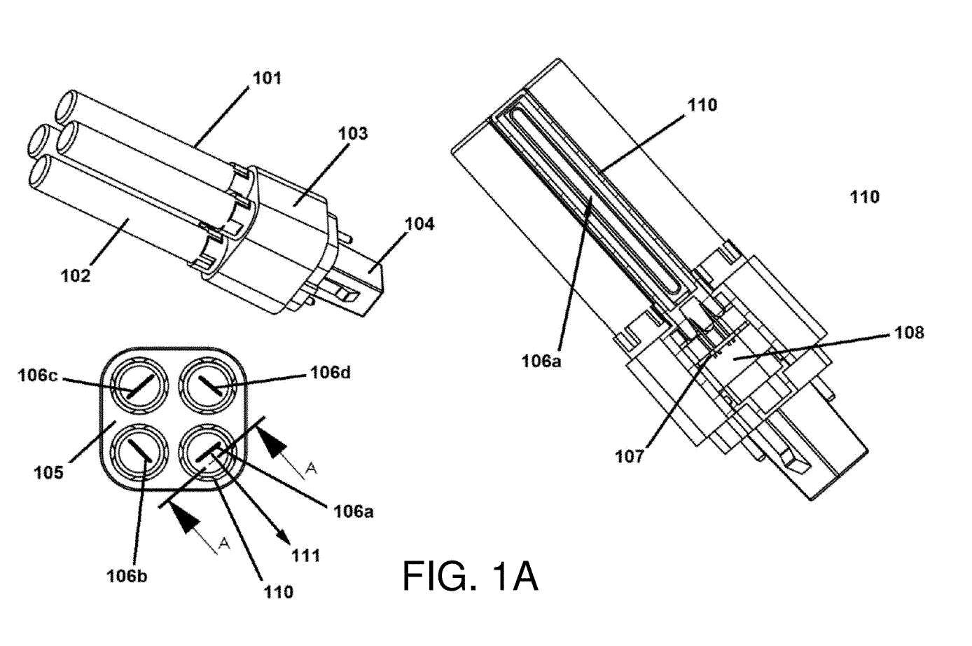

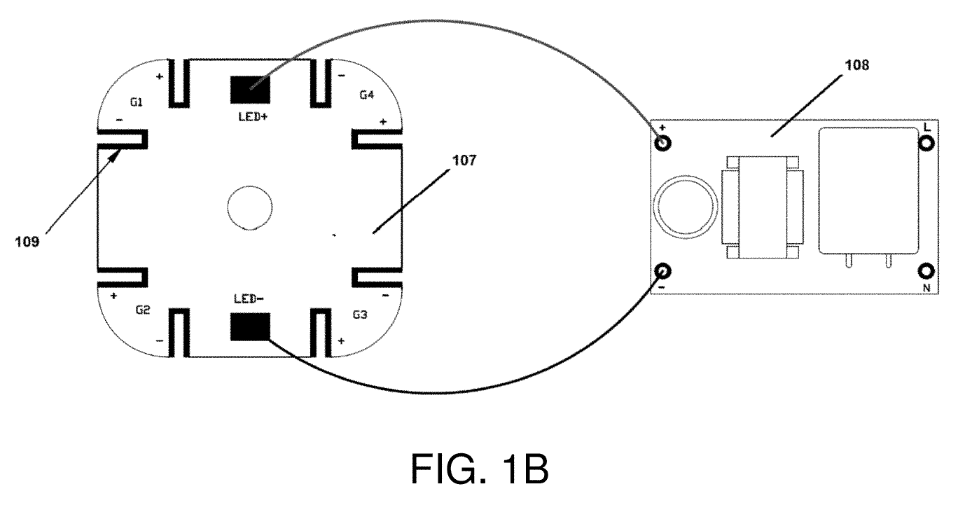

FIGS. 1A and 1B illustrate one non-limiting embodiment of the omnidirectional lighting device of the present disclosure. This lighting device 101 comprises four DC-powered elongated light sources (106a, 106b, 106c, 106d) and one driver base 103. The four elongated light sources protrude out of one side of the driver base 103 independent of each other as shown in the source mounting pattern 105. On the opposite side of the driver base 103 is the 2-pin PL-base connect connector 104. Taking a cross section view of the 4-source lighting device as indicated by the “A-A” cutting line on the source mounting pattern 105, one of the four elongated LED light sources 106a is shown to be enclosed by the cylindrical lens 110. The other three LED light sources 106b, 106c, and 106d are enclosed by their corresponding cylindrical lens. All four cylindrical lenses are aligned in parallel and of the same length. A PCB board 107 is used for mounting each of the four elongated LED light sources 109 onto the DC connector slots G1, G2, G3, and G4. The PCB board 107 is then wired to the LED driver 108. Both the PCB board 107 and the driver 108 reside inside the driver base 103.

The four elongated light sources (106a, 106b, 106c, 106d) emit light independently of each other, thus having the benefit of widening the overall lighting angle of the 4-source lighting device. Moreover, each light source has its own lighting surface, thus increasing the overall lighting surface area, as well as increasing the overall heat dissipation area, with the benefit of better heat management and longer lifetime for the lighting device.

The cylindrical lens 110 can be transparent or translucent or partially transparent and partially translucent. When needed, as in some other embodiments, a filtering material may be applied to the cylindrical lens for filtering the light emitted out of the elongated light source. This will have the effect of softening the light output, removing undesirable light wave, or changing the color (temperature) of the light output.

For safety reason, the space between the cylindrical lens 110 and the elongated light source 106 is preferred to be of vacuum or filled with inert gas.

It is possible to use 360-degree light source for each of the four light sources to achieve 360-degree lighting angle of the 4-source LED lighting device. For a light source with a narrower lighting angle (e.g., 120-degree) but coupled a cylindrical lens with a reflective material, it is possible to increase the lighting angle of the elongated LED light source to be greater than 180 degrees. The LED light source 106a emits light only with a 120-degree lighting angle centered in the direction 111. However, the cylindrical lens 110 may be applied with a reflective material making it a kind of diffuser, thus achieving a 180-degree lighting angle. Similarly, the elongated LED light sources 106b, 106c, and 106d each is facing away from the center of the driver base 103, and their cylindrical lens are applied with a reflective coating, thus enabling each light source to achieve 180 degree lighting angle, resulting the aggregate lighting angle of the 4-source lighting device to be 360 degrees. Since the LED light source is used for 106a, 106b, 106c, and 106d, the driver 108 in the driver base 103 is an LED driver in this embodiment.

In some embodiments, an OLED light source can be used and aligned in an elongated fashion and the cylindrical lens is applied with a reflective material to function as a diffuser to the light source.

In FIG. 1A, the electric connector 104 takes the form of two-pin PL connector. It may be four-pin PL connector. In other embodiments, the electric connector can take the form of any screw-in base, pin-base, or hole-base socket connector, or any standard or non-standard electrical connector.

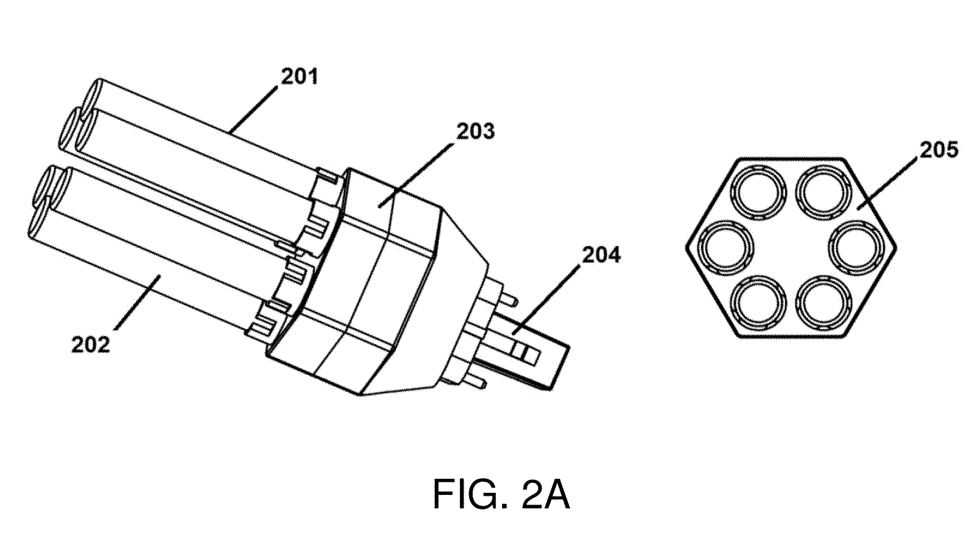

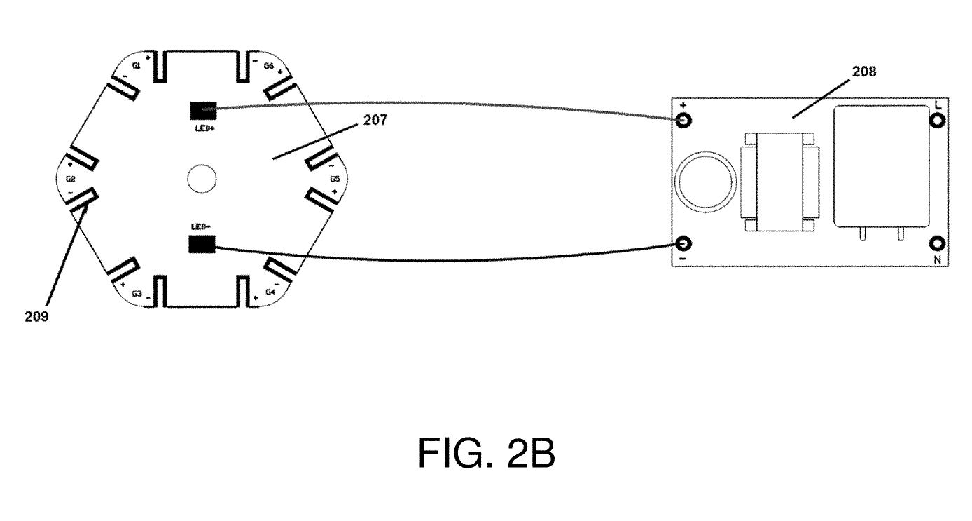

FIGS. 2A and 2B illustrate another embodiment of the multi-source lighting device of the present disclosure. This lighting device 201 comprises six elongated light sources (not shown) and one driver base 203, where each of the elongated light source is enclosed with a cylindrical lens 202. The six elongated light sources protrude out of one side of the driver base 203 independent of each other as shown in the source mounting pattern 205. On the opposite side of the driver base 203 is the 2-pin PL-base connector 204. Though not shown in FIG. 2A, a PCB board 207 resides inside of the driver base 203 for mounting the six elongated LED light sources 209, and the LED driver 208 also resides inside the driver base 203. The PCB board 207 is wired to the LED driver 208, and both reside inside the driver base 203.

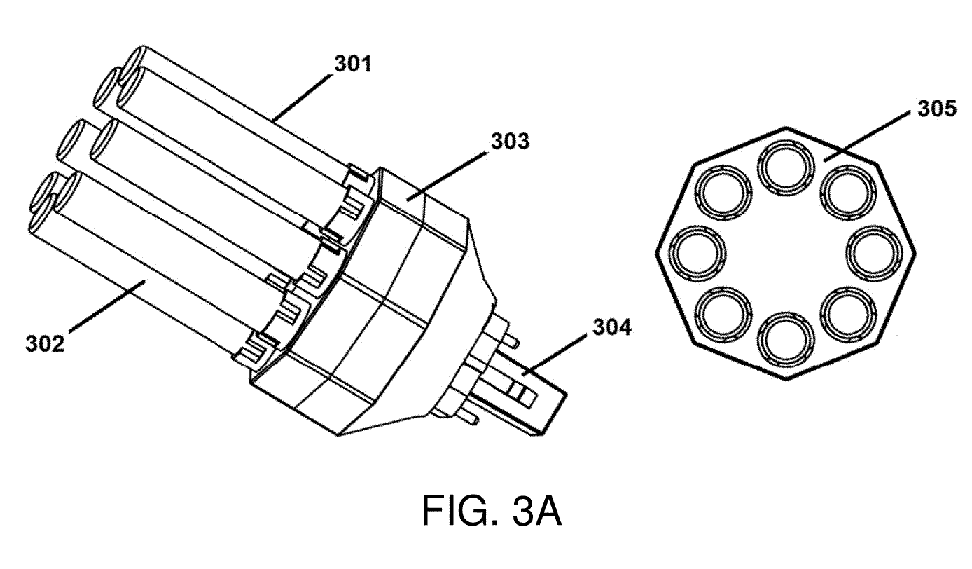

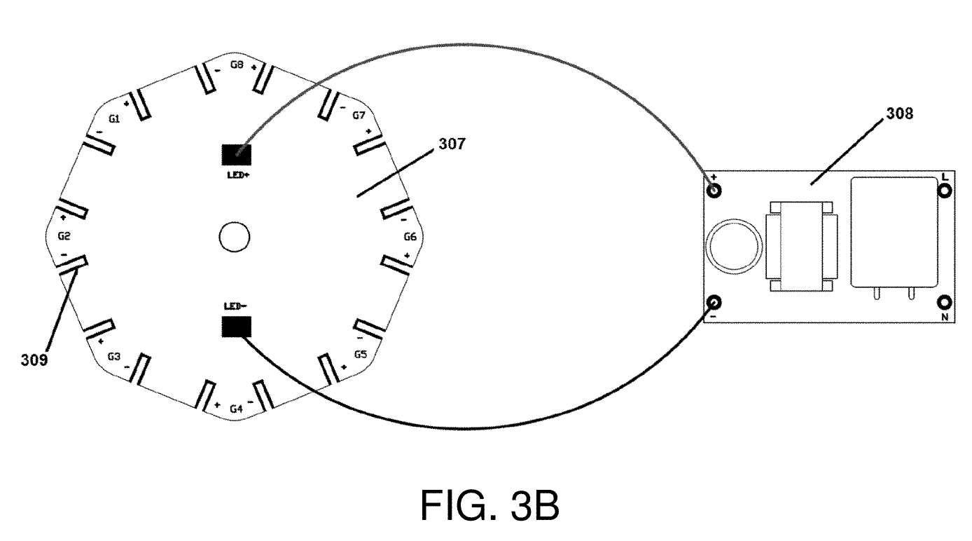

FIGS. 3A and 3B illustrate another embodiment of the multi-source lighting device of the present disclosure. This lighting device 301 comprises eight elongated light sources (not shown) and one driver base 303, where each of the elongated light sources is enclosed with a cylindrical lens 302. The eight light sources 302 protrude out of one side of the driver base 303 independent of each other as shown in the source mounting pattern 305. On the opposite side of the driver base 303 is the 2-pin PL-base connector 304. Though not shown in FIG. 3A, a PCB board 307 resides inside of the driver base 303 for mounting the eight elongated LED light sources 309, and the LED driver 308 also resides inside the driver base 303. The PCB board 307 is wired to the LED driver 308, and both reside inside the driver base 303.

The mounting patterns of multiple light sources in FIG. 1A 105, FIG. 2A 205, and FIG. 3A 305 are shown in circular fashion. Other mounting patterns are anticipated in order to (1) maximize the use of the mounting surface and the overall light output, or (2) create a particular lighting effect for aesthetic reason.

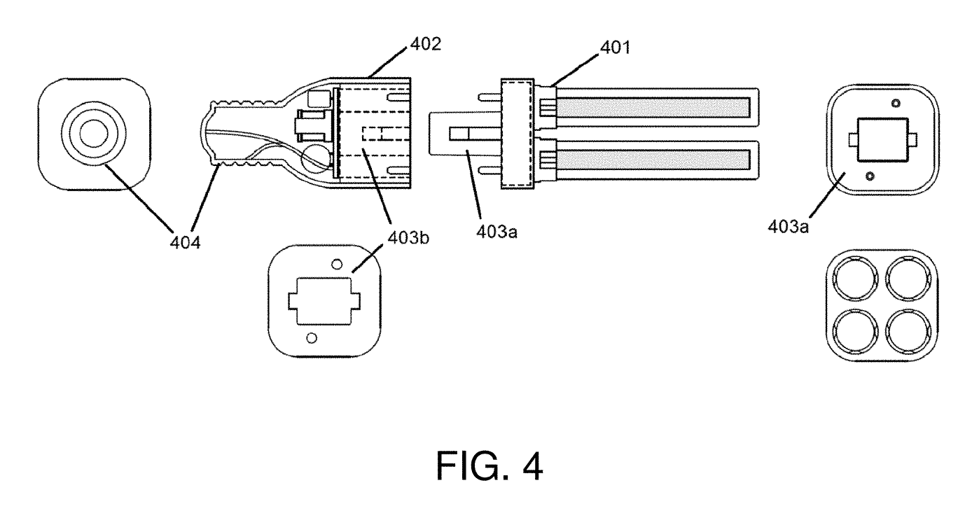

The FIG. 4 is another embodiment of the multi-source lighting device of the present disclosure. The four elongated light sources form a sub-assembly 401 and the driver base 402 itself another sub-assembly. These two sub-assemblies are combined through a PL socket connector 403a, 403b. No external force or additional part or component is needed for combing these two sub-assemblies. With this embodiment, the driver base can be easily upgraded with new functionality or replaced when the LED driver failed. The driver base connects to the external AC power source through a screw-in connector 404.

### Additional and Alternative Implementation Notes

Although the techniques have been described in language specific to certain applications, it is to be understood that the appended claims are not necessarily limited to the specific features or applications described herein. Rather, the specific features and examples are disclosed as non-limiting exemplary forms of implementing such techniques.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

What is claimed is:

1. A lighting device, comprising:
a driver base; and
a plurality of elongated light sources,
wherein:
the driver base comprises a driver configured to convert an external alternating-current (AC) power to a direct-current (DC) power and supply the DC power to the plurality of elongated light sources,
each of the plurality of elongated light sources protrudes independently out of the driver base,
each of the plurality of elongated light sources is enclosed in a respective cylindrical lens of a plurality of cylindrical lenses, and
an aggregate lighting angle of the plurality of elongated light sources is 360 degrees.

2. The lighting device of claim 1, wherein the plurality of the cylindrical lenses are aligned in parallel and of a same length.

3. The lighting device of claim 1, wherein at least one of the cylindrical lenses is transparent, translucent, or partially transparent and partially translucent.

4. The lighting device of claim 1, wherein a filtering material is applied to at least one of the cylindrical lenses and configured to filter light emitted out of the respective elongated light source.

5. The lighting device of claim 1, wherein a space between at least one of the cylindrical lenses and the respective elongated light source is vacuum or filled with an inert gas.

6. The lighting device of claim 1, wherein at least one of the elongated light sources comprises a light-emitting diode (LED) array, a filament-style LED light source, or an organic LED (OLED) light source aligned in an elongated style.

7. The lighting device of claim 1, wherein one side of the driver base is an electric connector in a form of any screw-in base, pin-base, hole-base socket connector, or any standard or non-standard electrical connector.

8. The light device of claim 1, further comprising a locking mechanism, wherein the plurality of elongated light sources form a driver-less sub-assembly, wherein the driver base with the driver form another sub-assembly, and wherein the two sub-assemblies are combined through the locking mechanism without using an external force or an additional part or component.
